(19) United States
(12) Patent Application Publication
(10) Pub. No.: US 2021/0172416 A1
(43) Pub. Date: Jun. 10, 2021

(54) NEW-TYPE WATERWHEEL ROTATING DEVICE

(71) Applicant: Xiaofei XIN, Baoding (CN)

(72) Inventor: Xiaofei XIN, Baoding (CN)

(21) Appl. No.: 16/747,556

(22) Filed: Jan. 21, 2020

(30) Foreign Application Priority Data
Dec. 5, 2019 (CN) 201922150041.X

(51) Int. Cl. F03B 7/00

(52) U.S. Cl. CPC F03B 7/00

(57) ABSTRACT

A new-type waterwheel rotating device includes a supporting plate, a rotating shaft, a rotating frame, a reinforcing ring and a power supply device, wherein the rotating frame includes a rotating ring and a plurality of rotating brackets, and the rotating ring is fixedly connected to the plurality of rotating brackets. Ends of the plurality of rotating brackets are welded to a first cylinder assembly, a second cylinder assembly, a third cylinder assembly, a fourth cylinder assembly, a fifth cylinder assembly, a sixth cylinder assembly, a seventh cylinder assembly and an eighth cylinder assembly, respectively. The first cylinder assembly includes a cylinder, a seal pipe, a vent pipe, a water outlet and a water inlet. The cylinder is connected to one end of the seal pipe, and the vent pipe is connected to the other end of the seal pipe.

### CROSS REFERENCE TO THE RELATED APPLICATIONS

This application is based upon and claims priority to Chinese Patent Application No. 201922150041.X, filed on Dec. 5, 2019, the entire contents of which are incorporated herein by reference.

### TECHNICAL FIELD

The present utility model relates to a rotating device, and in particular to a new-type waterwheel rotating device.

### BACKGROUND

Waterwheels are a kind of operating machine developed by laboring people in ancient China by making full use of hydraulic power. According to the literature, waterwheels appeared around the Eastern Han Dynasty. As an important part of agricultural civilization of China, waterwheels reflect creativity of the Chinese nation, witness the agricultural civilization of China, and provide witnesses for the history of water conservancy research. The invention of the waterwheel laid the foundation for people to live and work in peace and for the social harmony and stability.

Today's waterwheels have been used as a kind of landscape facility in parks. However, the existing waterwheels usually use a rotating device to directly rotate a rotating frame, which is less interesting. Therefore, those skilled in the art provide a new-type waterwheel rotating device to solve the problem mentioned in the background art described above.

### SUMMARY

The purpose of the present utility model is to provide a new-type waterwheel rotating device to solve the problem mentioned in the background art described above.

In order to achieve the purpose mentioned above, the present utility model provides the following technical solution:

a new-type waterwheel rotating device, comprising a supporting plate, a rotating shaft, a rotating frame, a reinforcing ring and a power supply device, wherein the rotating frame comprises a rotating ring and rotating brackets, the rotating ring and the several rotating brackets being all fixedly connected, and one ends of the several rotating brackets being welded to a first cylinder assembly, a second cylinder assembly, a third cylinder assembly, a fourth cylinder assembly, a fifth cylinder assembly, a sixth cylinder assembly, a seventh cylinder assembly and an eighth cylinder assembly; and

the first cylinder assembly comprises a cylinder, a seal pipe, a vent pipe, a water outlet and a water inlet, the cylinder being connected to the seal pipe, and the vent pipe being connected to the other end of the seal pipe.

As a further solution of the present utility model, the rotating frame rotates with the supporting plate via the rotating shaft, and the power supply device is disposed on the rotating frame.

As a still further solution of the present utility model, several water-proof colored lights are disposed on the rotating frame.

Compared with the prior art, the beneficial effects of the present utility model are as follows.

By means of air suction and water discharge through the piston motion of the cylinders, the vacuum cylinders under water float upwards. The cylinders above water discharge air and enter the water, which circulate in turn to make the waterwheel rotate continuously. The most important feature of this waterwheel is to utilize the buoyancy of water.

### BRIEF DESCRIPTION OF THE DRAWINGS

FIG. 1 is a structural schematic diagram of a new-type waterwheel rotating device.

FIG. 2 is a structural schematic diagram of a first cylinder assembly in a new-type waterwheel rotating device.

In the figures: 1. Supporting plate; 2. Rotating shaft; 3. Rotating frame; 4. Reinforcing ring; 5. Power supply device; 6. Water-proof colored light; 7. First cylinder assembly; 701. Cylinder; 702. Seal pipe; 703. Vent pipe; 704. Water outlet; 705. Water inlet; 8. Second cylinder assembly; 9. Third cylinder assembly; 10. Fourth cylinder assembly; 11. Fifth cylinder assembly; 12. Sixth cylinder assembly; 13. Seventh cylinder assembly; 14. Eighth cylinder assembly.

### DETAILED DESCRIPTION OF THE EMBODIMENTS

The technical solution of the embodiments of the present utility model will be clearly and completely described below in conjunction with the accompanying drawings for the embodiments of the present utility model; and obviously, the embodiments described are merely some, rather than all, of the embodiments of the present utility model. All other embodiments obtained by those of ordinary skill in the art based on the embodiments of the present utility model without any creative effort shall fall within the scope of protection of the present utility model.

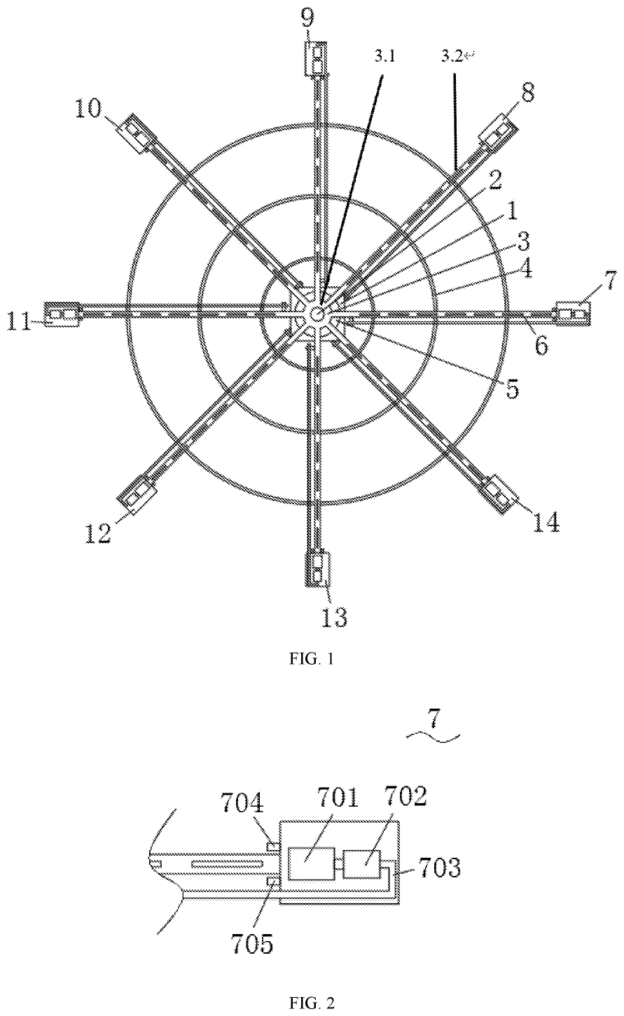

Refer to FIGS. 1-2, in an embodiment of the present utility model, a new-type waterwheel rotating device, comprising a supporting plate 1, a rotating shaft 2, a rotating frame 3, a reinforcing ring 4, and a power supply device 5, wherein the rotating frame 3 comprises a rotating ring 3.1 and rotating brackets 3.2, the rotating ring 3.1 and the several rotating brackets 3.2 being all fixedly connected, and one ends of the several rotating brackets 3.2 being welded to a first cylinder assembly 7, a second cylinder assembly 8, a third cylinder assembly 9, a fourth cylinder assembly 10, a fifth cylinder assembly 11, a sixth cylinder assembly 12, a seventh cylinder assembly 13 and an eighth cylinder assembly 14; and

the first cylinder assembly 7 comprises a cylinder 701, a seal pipe 702, a vent pipe 703, a water outlet 704 and a water inlet 705, the cylinder 701 being connected to the seal pipe 702, and the vent pipe 703 being connected to the other end of the seal pipe 702.

The rotating frame 3 rotates with the supporting plate 1 via the rotating shaft 2, the power supply device 5 is disposed on the rotating frame 3, and several water-proof colored lights 6 are disposed on the rotating frame 3.

When in use, it needs an external controller to control the power supply device 5 thereof and the first cylinder assembly 7, the second cylinder assembly 8, the third cylinder assembly 9, the fourth cylinder assembly 10, the fifth cylinder assembly 11, the sixth cylinder assembly 12, the seventh cylinder assembly 13 and the eighth cylinder assembly 14.

One end of the cylinder 701 is provided with the vent pipe 703 through the seal pipe 702 for air intake and discharge, and the other end thereof is open and is provided with the water outlet 704 and the water inlet 705, so that by means of air suction and water discharge through the piston motion of the cylinder 701, the air can be drawn into the cylinder 701 through the vent pipe 703 while discharging the water, so that the cylinder 701 is vacuum under water and floats upwards by virtue of the buoyancy of water to drive the rotating frame 3 to rotate.

This waterwheel rotating frame 3 is half in water and half above water.

I. The sixth cylinder assembly 12 and the seventh cylinder assembly 13 under water drive cylinder pistons by means of the power supply device 5 so that the cylinders under water discharge water out and at the same time draw in air such that the cylinders under water are evacuated to utilize the buoyancy of water.

II. At the same time, the second cylinder assembly 8 and first cylinder assembly 7 above water push cylinder rod pistons to discharge air through the power supply device 5 so that the water on water surface quickly enters the cylinders, so that the cylinders are quickly submerged into the water without affecting the rotation of the waterwheel.

The vacuum cylinders under water float upwards. The cylinders above water discharge air and enter the water, which circulate in turn to make the waterwheel rotate continuously. The most important feature of this waterwheel is to utilize the buoyancy of water.

The first cylinder assembly 7, the second cylinder assembly 8, the third cylinder assembly 9, the fourth cylinder assembly 10, the fifth cylinder assembly 11, the sixth cylinder assembly 12, the seventh cylinder assembly 13 and the eighth cylinder assembly 14 have the same structure.

The above description only relates to preferred embodiments of the present utility model, but the scope of protection of the present utility model is not limited thereto, and any equivalent replacements or modifications made by those skilled in the art according to the technical solution of the present utility model and the inventive concept thereof within the technical scope disclosed by the present utility model are all intended to be included within the scope of protection of the present utility model.

What is claimed is:

1. A new-type waterwheel rotating device, comprising:
a supporting plate,
a rotating shaft,
a rotating frame,
a reinforcing ring,
and a power supply device;
wherein
the rotating frame comprises a rotating ring and a plurality of rotating brackets; the rotating ring is fixedly connected to each of the plurality of rotating brackets; and ends of the plurality of rotating brackets are welded to a first cylinder assembly, a second cylinder assembly, a third cylinder assembly, a fourth cylinder assembly, a fifth cylinder assembly, a sixth cylinder assembly, a seventh cylinder assembly and an eighth cylinder assembly, respectively; and
the first cylinder assembly comprises a cylinder, a seal pipe, a vent pipe, a water outlet and a water inlet; the cylinder is connected to a first end of the seal pipe, and the vent pipe is connected to a second end of the seal pipe.

2. The new-type waterwheel rotating device according to claim 1, wherein, the rotating frame rotates with the supporting plate via the rotating shaft, and the power supply device is disposed on the rotating frame.

3. The new-type waterwheel rotating device according to claim 1, wherein, a plurality of water-proof colored lights are disposed on the rotating frame.
